(19) United States
(12) Patent Application Publication
(10) Pub. No.: US 2026/0058756 A1
(43) Pub. Date: Feb. 26, 2026

(54) IMAGE TRANSMITTING APPARATUS, IMAGE TRANSMISSION/RECEPTION SYSTEM, AND NON-TRANSITORY COMPUTER READABLE MEDIUM

(71) Applicant: FUJIFILM Business Innovation Corp., Tokyo (JP)

(72) Inventors: Yoshifumi BANDO, Kanagawa (JP); Hideki YAMASAKI, Kanagawa (JP); Ryoko SAITOH, Kanagawa (JP); Tomoyo NISHIDA, Kanagawa (JP)

(73) Assignee: FUJIFILM Business Innovation Corp., Tokyo (JP)

(21) Appl. No.: 19/058,837

(22) Filed: Feb. 20, 2025

(30) Foreign Application Priority Data
Aug. 20, 2024 (JP) 2024-138513

(51) Int. Cl. H04L 1/00; H04N 1/32

(52) U.S. Cl. CPC H04L 1/0061; H04N 1/32128; H04N 1/32641; H04N 1/32646; H04N 2201/3278

(57) ABSTRACT

An image transmitting apparatus includes: a transmission circuit that, in response to an input lock signal switching from a first logic state to a second logic state, transmits, to an image receiving apparatus, transmission data, the transmission data being data in which a clock signal is superimposed on image data, the first logic state indicating that communication has not been established, the second logic state indicating that communication has been established; and a lock-signal masking unit that receives the lock signal from the image receiving apparatus, and that, even when the received lock signal enters the second logic state and then varies to the first logic state, only in the case where the first logic state continues for a preset time or longer, outputs a lock signal of the first logic state to the transmission circuit.

### CROSS-REFERENCE TO RELATED APPLICATIONS

This application is based on and claims priority under 35 USC 119 from Japanese Patent Application No. 2024-138513 filed Aug. 20, 2024.

### BACKGROUND

### (i) Technical Field

The present disclosure relates to an image transmitting apparatus, an image transmission/reception system, and a non-transitory computer readable medium.

### (ii) Related Art

Japanese Unexamined Patent Application Publication No. 2017-063375 discloses a data communication control apparatus which controls a V-by-One (VBO) receiver by using an analog front end which converts an analog signal to a digital signal. Through this control, the data communication control apparatus suppresses influence from noise while the number of transmission lines is reduced, compared with the case of all-the-time control based on multiple control signals which are received through multiple transmission paths.

Japanese Unexamined Patent Application Publication No. 2019-110449 discloses a data communication apparatus which is capable of transmitting, from a reception-side circuit to a transmission-side circuit, data other than a lock signal through the same signal line.

### SUMMARY

Aspects of non-limiting embodiments of the present disclosure relate to an image transmitting apparatus, an image transmission/reception system, and a non-transitory computer readable medium which achieve improvement of noise immunity compared with the case in which a lock signal from an image receiving apparatus is input, as it is, to a transmission circuit of an image transmitting apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image transmitting apparatus comprising: a transmission circuit that, in response to an input lock signal switching from a first logic state to a second logic state, transmits, to an image receiving apparatus, transmission data, the transmission data being data in which a clock signal is superimposed on image data, the first logic state indicating that communication has not been established, the second logic state indicating that communication has been established; and a lock-signal masking unit that receives the lock signal from the image receiving apparatus, and that, even when the received lock signal enters the second logic state and then varies to the first logic state, only in a case where the first logic state continues for a preset time or longer, outputs a lock signal of the first logic state to the transmission circuit.

### BRIEF DESCRIPTION OF THE DRAWINGS

Exemplary embodiment of the present disclosure will be described in detail based on the following figures, wherein:

FIG. 1 is a block diagram illustrating the configuration of an image transmission/reception system as a comparison example;

FIG. 2 is a block diagram illustrating the configuration of an image transmission/reception system according to an exemplary embodiment of the present disclosure;

FIG. 3 is a timing chart for describing operations performed when an image transmission/reception system according to an exemplary embodiment of the present disclosure is initialized;

FIG. 4 is a timing chart for describing operations performed when a short noise is superimposed on a LOCKN signal;

FIG. 5 is a timing chart for describing operations performed in response to detection of an error in the case where a LOCKN signal is set to the H level for a time longer than the time period of noise; and

FIG. 6 is a timing chart for describing operations performed in response to detection of an error in the case where a LOCKN signal is varied between the H level and the L level a predetermined number of times.

### DETAILED DESCRIPTION

An exemplary embodiment of the present disclosure will be described in detail by referring to the drawings.

A communication standard called V-by-One® may be used in transmission/reception of image data. V-by-One uses a clock-embedded system in which transmission data, on the transmission side, of a pair of differential signals of data signal and clock information is transmitted to the reception side. When image data is transmitted/received in the clock-embedded system, the reception side performs a clock data recovery (CDR) training process on the transmission data, which is received from the transmission side, to extract the clock signal and the image data from the received transmission data. Through this process, V-by-One achieves high-speed transmission of image data because a skew is difficult to occur between the clock signal and the image data.

In V-by-One, when the CDR training process is completed on the reception side and extraction of a clock signal from transmission data is ready to be performed, notification indicating that communication has been established is transmitted by using a LOCKN signal from the reception side to the transmission side. Specifically, the LOCKN signal at the high level (hereinafter abbreviated as the H level) indicates that extraction of a clock signal from transmission data is not ready, that is, communication has not been established. The LOCKN signal at the low level (hereinafter abbreviated as the L level) indicates that extraction of a clock signal from transmission data is ready, that is, communication has been established. On the transmission side, the logic of the LOCKN signal transmitted from the reception side is checked. When the L level, which indicates that communication has been established, is confirmed, transmission data including image data is transmitted to the reception side.

However, after communication has been established between the transmission side and the reception side, when the logic of the LOCKN signal varies to the H level which indicates that the communication has not been established, the transmission side stops transfer of image data, and performs a CDR process again. The LOCKN signal, which is a single-ended signal, has a low noise immunity. This causes the following case: assume the case in which the LOCKN signal, which is to be at the L level, is set to the H level due to superimposition of noise on the LOCKN signal while transmission data including image data is being transmitted from the transmission side to the reception side; in this case, although the CDR on the reception side is in the normal lock state, a CDR training process is performed on the transmission side. As a result, there arises a problem in that transfer of image data is stopped although the stopping is not necessary. Therefore, improvement of noise immunity has been demanded so that, even when noise is superimposed on the LOCKN signal, transfer of image data is not stopped.

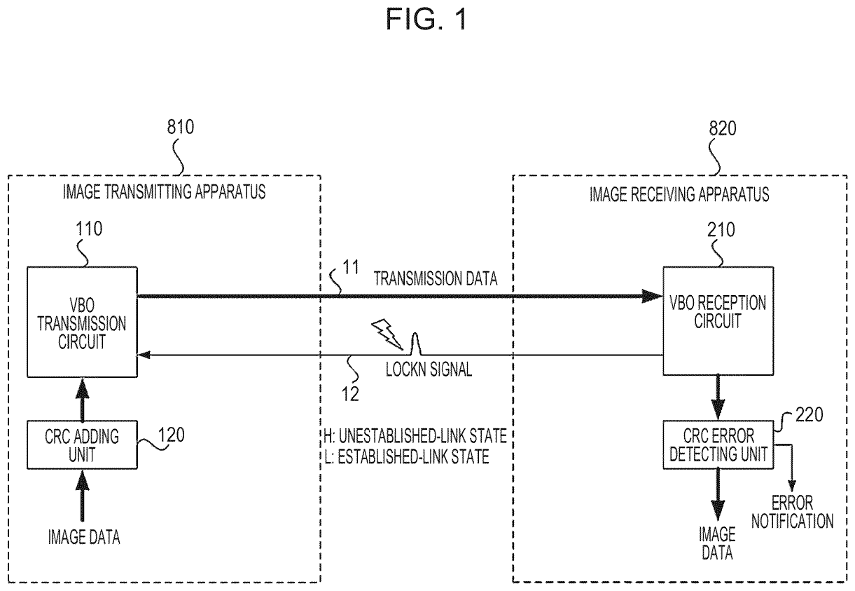

Before the configuration of an image transmission/reception system according to the present exemplary embodiment is described, the configuration of an image transmission/reception system, to which the technique of the present disclosure is not applied, will be described as a comparison example by referring to FIG. 1.

As illustrated in FIG. 1, an image transmission/reception system according to the comparison example includes an image transmitting apparatus 810 and an image receiving apparatus 820. The image transmitting apparatus 810 includes a V-by-One (VBO) transmission circuit 110 and a cyclic redundancy check (CRC) adding unit 120. The image receiving apparatus 820 includes a VBO reception circuit 210 and a CRC error detecting unit 220.

Such an image transmission/reception system is used, for example, to receive/transmit image data, for example, between a photographing device or a scanner device and a signal processor and between a signal processor and an image display device.

The CRC adding unit 120 adds a CRC code, which is an error detecting code, to image data that is to be transmitted to the image receiving apparatus 820. Specifically, the CRC adding unit 120 adds, as a CRC code, the remainder of division of image data by a generator polynomial, which has been set in advance, to the image data.

The VBO transmission circuit 110 transmits, to the image receiving apparatus 820, transmission data 11 obtained by superimposing a clock signal on image data, and receives a LOCKN signal 12 from the image receiving apparatus 820. The LOCKN signal 12 whose logic state is the H level indicates that the image receiving apparatus 820 has not completed a CDR training process and that a clock signal has not been extracted from the transmission data 11, that is, the communication (link) has not been established. The LOCKN signal 12 whose logic state is the L level indicates that the image receiving apparatus 820 has completed a CDR training process and that a clock signal has been extracted from the transmission data 11, that is, the communication has been established. Specifically, the LOCKN signal 12 is a lock signal indicating the lock state of a phase locked loop (PLL) circuit for CDR which is installed in the VBO reception circuit 210.

Therefore, when the input LOCKN signal 12 varies from the H level, which is the logic state indicating that the link has not been established, to the L level, which is the logic state indicating that the link has been established, the VBO transmission circuit 110 transmits, to the image receiving apparatus 820, the transmission data 11 in which a clock signal is superimposed on image data.

The VBO reception circuit 210 extracts a clock signal from the transmission data 11 which has been transmitted from the image transmitting apparatus 810, and obtains image data from the transmission data 11 by using the extracted clock signal. When extraction of a clock signal from the transmission data 11 is ready, the VBO reception circuit 210 varies the LOCKN signal 12, which indicates whether the communication has been established, from the H level, which is the logic state indicating that the communication has not been established, to the L level, which is the logic state indicating that the communication has been established.

The CRC error detecting unit 220 performs error detection on the image data by using the error detecting code added to the image data obtained by the VBO reception circuit 210. Specifically, the CRC error detecting unit 220 extracts a CRC code which has been added to the image data received by the VBO reception circuit 210, and checks if the image data is damaged by determining whether the extracted CRC code matches the remainder of division of the image data by the generator polynomial which has been set in advance. When an error is detected in the received image data, the CRC error detecting unit 220 transmits, to a subsequent circuit, an error notification indicating that the received image data may have an error.

After start of transmission of the transmission data 11 to the image receiving apparatus 820, when the LOCKN signal 12 varies from the H level to the L level, the VBO transmission circuit 110 determines that the image receiving apparatus 820 has completed the CDR training, and transmits, to the image receiving apparatus 820, image data, on which a clock signal is superimposed, as the transmission data 11. When the LOCKN signal 12 varies from the L level to the H level during transmission of the transmission data 11 to the image receiving apparatus 820, the VBO transmission circuit 110 determines that the CDR circuit has been unlocked in the image receiving apparatus 820, and stops transmission of the transmission data 11. Then, the VBO transmission circuit 110 starts a CDR training process again.

The LOCKN signal, which is a single-ended signal, has a noise immunity lower than that of the transmission data 11 which is a pair of differential signals. Therefore, some noise, which occurs between the image transmitting apparatus 810 and the image receiving apparatus 820, may cause the state in which the logic state of the LOCKN signal 12 varies from the L level to the H level and stays at the H level just for a moment. If it is detected that the LOCKN signal 12 is at the H level even for a moment, the VBO transmission circuit 110 determines that the CDR circuit has been unlocked in the image receiving apparatus 820, and stops transmission of the transmission data 11.

### An Exemplary Embodiment using a Technique of the Present Disclosure

Accordingly, an image transmission/reception system according to the present exemplary embodiment employs the configuration described below. Thus, the noise immunity is improved compared with the case in which a LOCKN signal from an image receiving apparatus is input, as it is, to a transmission circuit of an image transmitting apparatus.

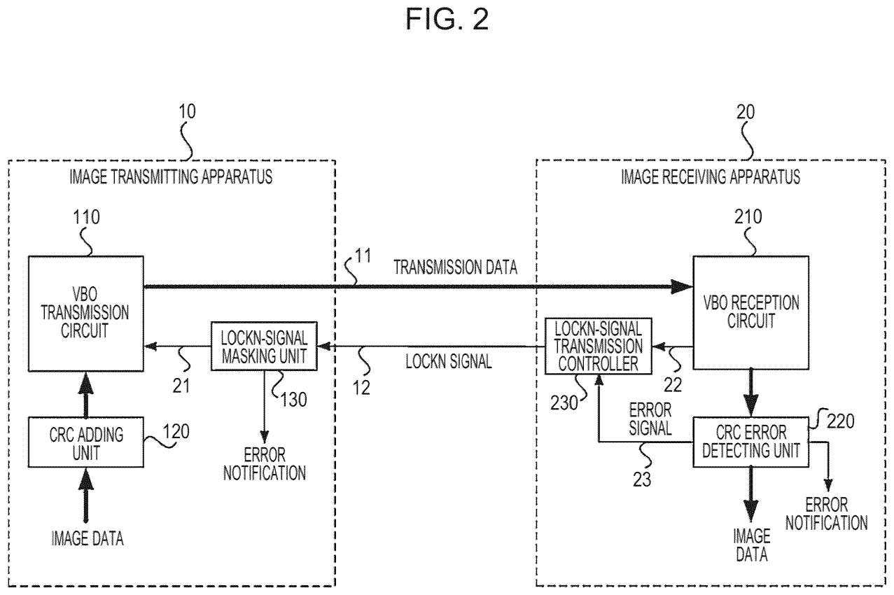

FIG. 2 illustrates the configuration of an image transmission/reception system according to an exemplary embodiment of the present disclosure. In FIG. 2, the same configurations as those in FIG. 1 are designated with the same reference numerals, and will not be described.

As illustrated in FIG. 2, the image transmission/reception system according to the present exemplary embodiment includes an image transmitting apparatus 10 and an image receiving apparatus 20.

The image transmitting apparatus 10 includes the VBO transmission circuit 110, the CRC adding unit 120, and a LOCKN-signal masking unit 130. The image receiving apparatus 20 includes the VBO reception circuit 210, the CRC error detecting unit 220, and a LOCKN-signal transmission controller 230.

The image transmitting apparatus 10 has the configuration of the image transmitting apparatus 810 in FIG. 1 plus the LOCKN-signal masking unit 130. The image receiving apparatus 20 has the configuration of the image receiving apparatus 820 in FIG. 1 plus the LOCKN-signal transmission controller 230.

The VBO transmission circuit 110 according to the present exemplary embodiment transmits, to the image receiving apparatus 20, the transmission data 11 in which a clock signal is superimposed on image data. The VBO transmission circuit 110 receives, as a transmission-side LOCKN signal 21, the LOCKN signal 12 from the image receiving apparatus 20 through the LOCKN-signal masking unit 130. When the input transmission-side LOCKN signal 21 varies from the H level, which is the logic state indicating that the link has not been established, to the L level, which is the logic state indicating that the link has been established, the VBO transmission circuit 110 transmits, to the image receiving apparatus 20, the transmission data 11 in which a clock signal is superimposed on image data.

The LOCKN-signal masking unit 130 receives the LOCKN signal 12 from the image receiving apparatus 20. Even in the case where the received LOCKN signal 12 varies to the L level and then to the H level, only when the received LOCKN signal 12 varies in a preset manner, the LOCKN-signal masking unit 130 outputs, to the VBO transmission circuit 110, the transmission-side LOCKN signal 21 of the H level.

When the LOCKN signal 12 received from the image receiving apparatus 20 varies in the preset manner, the LOCKN-signal masking unit 130 outputs an error notification to a subsequent circuit.

When an error is detected in the received image data, the CRC error detecting unit 220 according to the present exemplary embodiment transmits an error notification to a subsequent circuit, and outputs an error signal 23 of the H level to the LOCKN-signal transmission controller 230.

When a reception-side LOCKN signal 22, which is output from the VBO reception circuit 210, varies from the L level to the H level, the LOCKN-signal transmission controller 230 outputs, to the image transmitting apparatus 10, a signal, which varies in the preset manner, as the LOCKN signal 12. When the CRC error detecting unit 220 detects an error in image data and the error signal 23 is set to the H level, the LOCKN-signal transmission controller 230 also outputs, to the image transmitting apparatus 10, a signal, which varies in the preset manner, as the LOCKN signal 12.

According to the present exemplary embodiment, when the reception-side LOCKN signal 22 which is output from the VBO reception circuit 210 varies from the L level to the H level, the LOCKN-signal transmission controller 230 outputs, to the image transmitting apparatus 10, a signal, in which the H level continues for a preset time, for example, 10 ms or longer, as the LOCKN signal 12.

Even in the case where the LOCKN signal 12 is received from the image receiving apparatus 20 and the received LOCKN signal 12 varies to the L level and then to the H level, the LOCKN-signal masking unit 130 outputs, to the VBO transmission circuit 110, the transmission-side LOCKN signal 21 of the H level only when the H level continues for the preset time, for example, 10 ms or longer.

The time, 10 ms, is an exemplary time which is longer than the predicted time for which the logic state of the LOCKN signal 12 is affected due to occurrence of noise. For example, when the time for which the logic state of the LOCKN signal 12 is affected due to noise is about several milliseconds, the time, 10 ms, is set as a time sufficiently longer than the predicted time for which the logic state of the LOCKN signal 12 is affected due to occurrence of noise, as described above. When the time for which the logic state of the LOCKN signal 12 is affected due to noise is predicted to be much longer, a time of about several tens of milliseconds may be set as a time sufficiently longer than the predicted time for which the logic state of the LOCKN signal 12 is affected due to noise.

As another configuration, when the reception-side LOCKN signal 22, which is output from the VBO reception circuit 210, varies from the L level to the H level, the LOCKN-signal transmission controller 230 may output, to the image transmitting apparatus 10, the LOCKN signal 12 which varies between the H level and the L level a predetermined number of times and which is then set to the H level. In this case, the LOCKN-signal masking unit 130 is set so that, when the LOCKN signal 12 varies between the H level and the L level a predetermined number of times or more and is then set to the H level, the transmission-side LOCKN signal 21 of the H level is output to the VBO transmission circuit 110.

For example, when the reception-side LOCKN signal 22, which is output from the VBO reception circuit 210, varies from the L level to the H level, the LOCKN-signal transmission controller 230 may output, to the image transmitting apparatus 10, the LOCKN signal 12 which varies between the H level and the L level 100 times and is then set to the H level. In this case, the LOCKN-signal masking unit 130 is set so that, when the LOCKN signal 12 varies between the H level and the L level 100 time or more and is then set to the H level, the transmission-side LOCKN signal 21 of the H level is output to the VBO transmission circuit 110.

According to the present exemplary embodiment, the configuration in which the LOCKN-signal masking unit 130 is included in the image transmitting apparatus 10 and in which the LOCKN-signal transmission controller 230 is included in the image receiving apparatus 20 will be described. However, in the case where the transmission-side LOCKN signal 21 is set to the H level when the H level state of the LOCKN signal 12 continues for a preset time or longer, the configuration including only the LOCKN-signal masking unit 130 in the image transmitting apparatus 10 also achieves improvement of noise immunity. However, in the case of such a configuration, an error in image data, which is detected by the CRC error detecting unit 220, is not notified to the image transmitting apparatus 10.

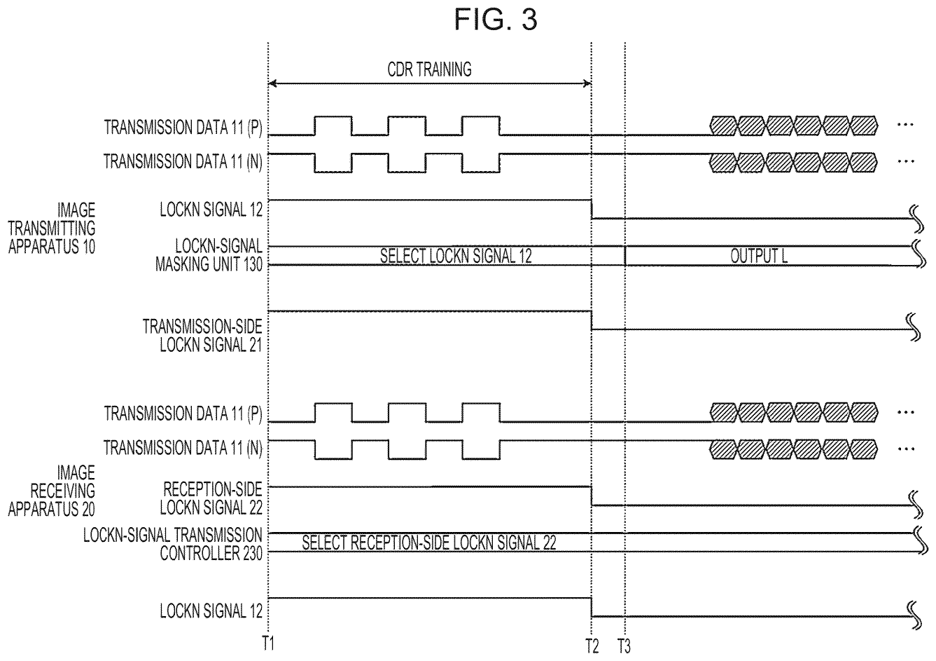

Operations of the image transmission/reception system according to the present exemplary embodiment will be described by referring to the timing charts in FIGS. 3 to 6.

Operations, in initialization, of the image transmission/reception system according to the present exemplary embodiment will be described by referring to the timing chart in FIG. 3.

At time T1 in the initial state, the LOCKN-signal masking unit 130 selects the LOCKN signal 12 received from the image receiving apparatus 20, and outputs the selected LOCKN signal 12, as it is, as the transmission-side LOCKN signal 21. The LOCKN-signal transmission controller 230 selects the reception-side LOCKN signal 22 from the VBO reception circuit 210, and outputs the selected reception-side LOCKN signal 22 as the LOCKN signal 12.

In this state, a CDR training process starts between the image transmitting apparatus 10 and the image receiving apparatus 20.

When the CDR training process completes at time T2, the VBO reception circuit 210 sets the reception-side LOCKN signal 22 to the L level. Accordingly, the LOCKN-signal transmission controller 230 sets the LOCKN signal 12 to the L level. As a result, the LOCKN-signal masking unit 130 sets the transmission-side LOCKN signal 21 to the L level, and the VBO transmission circuit 110 grasps completion of the CDR training process.

After that, completion of the CDR training process causes the LOCKN-signal masking unit 130 to fix the transmission-side LOCKN signal 21 at the L level at time T3. Image data is transmitted/received between the image transmitting apparatus 10 and the image receiving apparatus 20 through the transmission data 11.

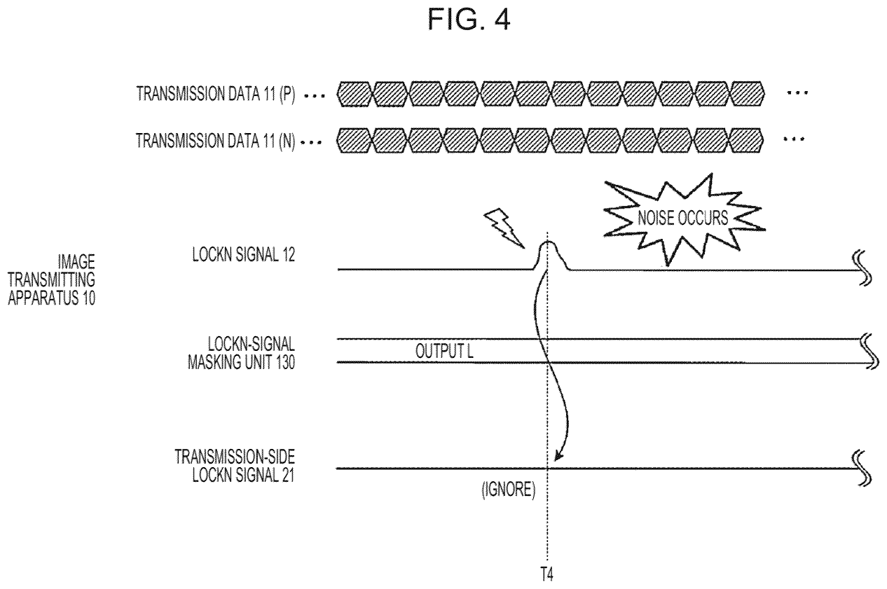

Operations performed when a short noise is superimposed on the LOCKN signal 12 in such a state will be described by referring to the timing chart in FIG. 4.

FIG. 4 shows that noise from the outside is superimposed on the LOCKN signal 12 at time T4. However, even if the LOCKN signal 12 spikes to the H level just for a moment, unless the H-level state of the LOCKN signal 12 continues for 10 ms or longer, the LOCKN-signal masking unit 130 does not vary the logic state of the transmission-side LOCKN signal 21. Therefore, at time T4, the logic state of the transmission-side LOCKN signal 21 remains at the L level, and occurrence of the noise is ignored. As a result, the VBO transmission circuit 110 continues to transmit, to the image receiving apparatus 20, image data through the transmission data 11 without being affected by occurrence of the noise.

Thus, the image transmission/reception system according to the present exemplary embodiment achieves improvement of the noise immunity compared with the case in which the reception-side LOCKN signal 22, which is output from the VBO reception circuit 210 of the image receiving apparatus 20, is input, as it is, to the VBO transmission circuit 110.

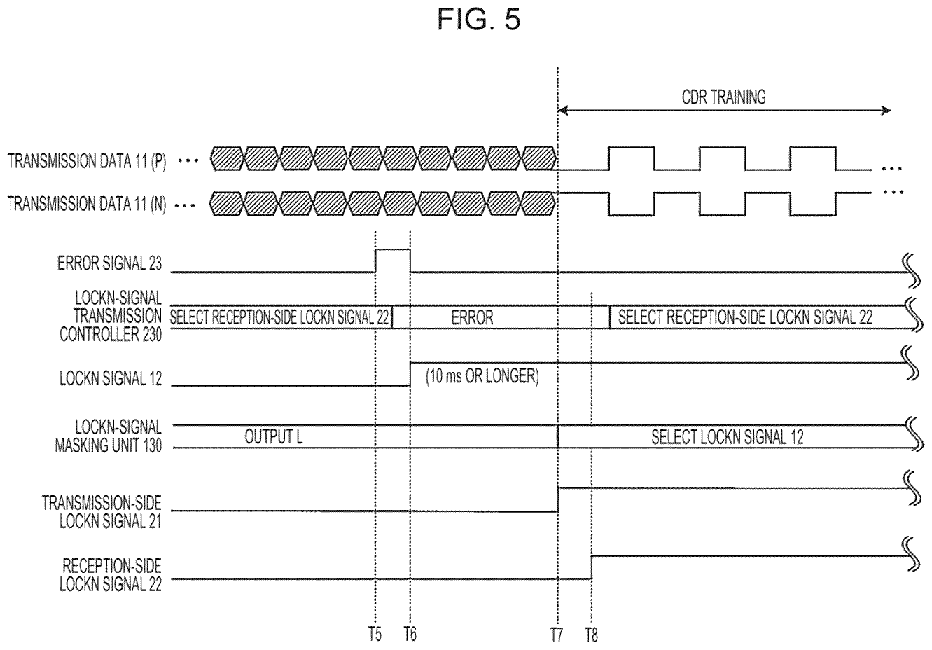

Operations performed when the CRC error detecting unit 220 of the image receiving apparatus 20 detects an error will be described by referring to the timing chart in FIG. 5.

In FIG. 5, at time T5, the CRC error detecting unit 220 detects an error in image data, and sets the error signal 23 to the H level. Therefore, the LOCKN-signal transmission controller 230 determines that some error has occurred. Thus, at time T6, the LOCKN-signal transmission controller 230 sets the LOCKN signal 12 to the H level, and causes the H-level state to continue for 10 ms or longer.

Since the H-level state of the LOCKN signal 12 continues for 10 ms or longer, at time T7, the LOCKN-signal masking unit 130 switches from the state of fixedly outputting the L level to the state of selecting the LOCKN signal 12. As a result, the LOCKN-signal masking unit 130 varies the transmission-side LOCKN signal 21, which has been fixed at the L level, to the H level.

Therefore, the VBO transmission circuit 110 determines that the image receiving apparatus 20 enters the state of being not capable of receiving image data normally. The VBO transmission circuit 110 stops the transmission of image data, and starts a CDR training process. Accordingly, the VBO reception circuit 210 varies the reception-side LOCKN signal 22 to the H level. This causes the LOCKN-signal transmission controller 230 to select the reception-side LOCKN signal 22 for output as the LOCKN signal 12.

When the CDR training process, which has started as described above, completes, like the operations in FIG. 3, image data is transmitted/received between the image transmitting apparatus 10 and the image receiving apparatus 20 through the transmission data 11.

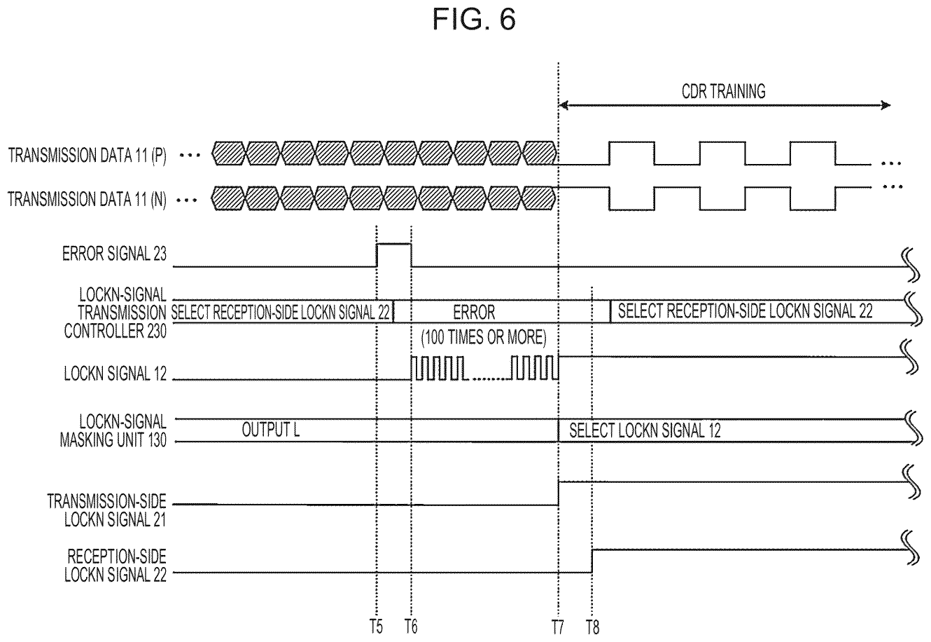

FIG. 5 describes operations performed in the case where, in response to detection of an error, the H-level state of the LOCKN signal 12 continues for a time longer than the time period of noise. In contrast, FIG. 6 illustrates a timing chart of operations performed in the case where, in response to detection of an error, the LOCKN signal 12 varies between the H level and the L level in a preset period a predetermined number of times, for example, 100 times or more.

The timing chart in FIG. 6 is different from that in FIG. 5 only in that, due to the error signal 23 which is set to the H level at time T5, the LOCKN-signal transmission controller 230 varies the LOCKN signal 12 between the H level and the L level 100 times or more, and then sets the LOCKN signal 12 to the H level. The operations other than this in FIG. 6 are the same as those in the timing chart in FIG. 5, and will not be described.

In the present exemplary embodiment described above, the case in which the LOCKN-signal masking unit 130 and the LOCKN-signal transmission controller 230 are configured by using hardware is described. However, the technique of the present disclosure is not limited to such a configuration. Each of the LOCKN-signal masking unit 130 and the LOCKN-signal transmission controller 230 may be configured by using a processor such as a central processing unit (CPU). A program stored in a storage device or the like may be made to be executed on the processor. Thus, the operations of the LOCKN-signal masking unit 130 and the LOCKN-signal transmission controller 230 may be implemented.

In the embodiments above, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

“System” in the present exemplary embodiment encompasses both a system configured with multiple devices and a system configured with a single device.

The technique of the present disclosure may be applied also to a program and a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image transmitting apparatus comprising:
a transmission circuit that, in response to an input lock signal switching from a first logic state to a second logic state, transmits, to an image receiving apparatus, transmission data, the transmission data being data in which a clock signal is superimposed on image data, the first logic state indicating that communication has not been established, the second logic state indicating that communication has been established; and
a lock-signal masking unit that receives the lock signal from the image receiving apparatus, and that, even when the received lock signal enters the second logic state and then varies to the first logic state, only in a case where the first logic state continues for a preset time or longer, outputs a lock signal of the first logic state to the transmission circuit.
   (((2)))

The image transmitting apparatus according to (((1))),
wherein, when a period for which the lock signal is in the first logic state continues for a time longer than a predicted time for which the logic state of the lock signal is affected by occurrence of noise, the lock-signal masking unit outputs the lock signal of the first logic state to the transmission circuit.
   (((3)))

An image transmission/reception system comprising:
an image receiving apparatus including:
   a reception circuit that extracts a clock signal from transmission data to obtain image data from the transmission data by using the extracted clock signal, the transmission data being transmitted from an image transmitting apparatus, and that, when extraction of a clock signal from the transmission data is ready, varies a lock signal from a first logic state to a second logic state, the lock signal indicating whether communication has been established, the first logic state indicating that the communication has not been established, the second logic state indicating that the communication has been established; and
   a lock-signal transmission controller that, when the lock signal which is output from the reception circuit varies from the second logic state to the first logic state, outputs, to the image transmitting apparatus, a signal as a lock signal, the output signal varying in a preset manner; and
the image transmitting apparatus including:
   a transmission circuit that, when the lock signal which is input varies from the first logic state to the second logic state, transmits, to the image receiving apparatus, the transmission data in which a clock signal is superimposed on image data; and
   a lock-signal masking unit that receives the lock signal from the image receiving apparatus, and that, when the received lock signal varies in the preset manner, outputs a lock signal of the first logic state to the transmission circuit.
      (((4)))

The image transmission/reception system according to (((3))),
wherein, when the lock signal which is output from the reception circuit varies from the second logic state to the first logic state, the lock-signal transmission controller outputs, to the image transmitting apparatus, a lock signal in which the first logic state continues for a preset time or longer, and
wherein, when the period for which the lock signal is in the first logic state continues for the preset time or longer, the lock-signal masking unit outputs a lock signal of the first logic state to the transmission circuit.
   (((5)))

The image transmission/reception system according to (((4))),
wherein, in a case where the lock signal which is output from the reception circuit varies from the second logic state to the first logic state, when the period for which the lock signal is in the first logic state continues at least for a time longer than a predicted time for which the logic state of the lock signal is affected by occurrence of noise, the lock-signal transmission controller outputs, to the image transmitting apparatus, a lock signal in which the first logic state continues for the preset time or longer.
   (((6)))

The image transmission/reception system according to (((3))),
wherein, when the lock signal which is output from the reception circuit varies from the second logic state to the first logic state, the lock-signal transmission controller outputs, to the image transmitting apparatus, a lock signal which enters the first logic state after varying between the first logic state and the second logic state a preset number of times, and
wherein, when the lock signal enters the first logic state after varying between the first logic state and the second logic state the preset number of times or more, the lock-signal masking unit outputs a lock signal of the first logic state to the transmission circuit.
   (((7)))

The image transmission/reception system according to (((3))),
wherein the image transmitting apparatus further includes an adding unit that adds an error detecting code to image data which is to be transmitted to the image receiving apparatus,
wherein the image receiving apparatus further includes a detection unit that performs error detection on the image data by using the error detecting code added to the image data obtained by the reception circuit, and
wherein, in response to the detection unit detecting an error in the image data, the lock-signal transmission controller outputs, to the image transmitting apparatus, a signal as a lock signal, the output signal varying in the preset manner.
   (((8)))

A program causing a computer to execute a process comprising:
in an image transmitting apparatus including a transmission circuit that, in response to an input lock signal switching from a first logic state to a second logic state, the first logic state indicating that communication has not been established, the second logic state indicating that communication has been established, transmits, to an image receiving apparatus, transmission data in which a clock signal is superimposed on image data, receiving the lock signal from the image receiving apparatus; and
even when the received lock signal enters the second logic state and then varies to the first logic state, only in a case where the first logic state continues for a preset time or longer, outputting a lock signal of the first logic state to the transmission circuit.

What is claimed is:

1. An image transmitting apparatus comprising:
a transmission circuit that, in response to an input lock signal switching from a first logic state to a second logic state, transmits, to an image receiving apparatus, transmission data, the transmission data being data in which a clock signal is superimposed on image data, the first logic state indicating that communication has not been established, the second logic state indicating that communication has been established; and
a lock-signal masking unit that receives the lock signal from the image receiving apparatus, and that, even when the received lock signal enters the second logic state and then varies to the first logic state, only in a case where the first logic state continues for a preset time or longer, outputs a lock signal of the first logic state to the transmission circuit.

2. The image transmitting apparatus according to claim 1,
wherein, when a period for which the lock signal is in the first logic state continues for a time longer than a predicted time for which the logic state of the lock signal is affected by occurrence of noise, the lock-signal masking unit outputs the lock signal of the first logic state to the transmission circuit.

3. An image transmission/reception system comprising:
an image receiving apparatus including:
a reception circuit that extracts a clock signal from transmission data to obtain image data from the transmission data by using the extracted clock signal, the transmission data being transmitted from an image transmitting apparatus, and that, when extraction of a clock signal from the transmission data is ready, varies a lock signal from a first logic state to a second logic state, the lock signal indicating whether communication has been established, the first logic state indicating that the communication has not been established, the second logic state indicating that the communication has been established; and
a lock-signal transmission controller that, when the lock signal which is output from the reception circuit varies from the second logic state to the first logic state, outputs, to the image transmitting apparatus, a signal as a lock signal, the output signal varying in a preset manner; and
the image transmitting apparatus including:
a transmission circuit that, when the lock signal which is input varies from the first logic state to the second logic state, transmits, to the image receiving apparatus, the transmission data in which a clock signal is superimposed on image data; and
a lock-signal masking unit that receives the lock signal from the image receiving apparatus, and that, when the received lock signal varies in the preset manner, outputs a lock signal of the first logic state to the transmission circuit.

4. The image transmission/reception system according to claim 3,
wherein, when the lock signal which is output from the reception circuit varies from the second logic state to the first logic state, the lock-signal transmission controller outputs, to the image transmitting apparatus, a lock signal in which the first logic state continues for a preset time or longer, and
wherein, when the period for which the lock signal is in the first logic state continues for the preset time or longer, the lock-signal masking unit outputs a lock signal of the first logic state to the transmission circuit.

5. The image transmission/reception system according to claim 4,
wherein, in a case where the lock signal which is output from the reception circuit varies from the second logic state to the first logic state, when the period for which the lock signal is in the first logic state continues at least for a time longer than a predicted time for which the logic state of the lock signal is affected by occurrence of noise, the lock-signal transmission controller outputs, to the image transmitting apparatus, a lock signal in which the first logic state continues for the preset time or longer.

6. The image transmission/reception system according to claim 3,
wherein, when the lock signal which is output from the reception circuit varies from the second logic state to the first logic state, the lock-signal transmission controller outputs, to the image transmitting apparatus, a lock signal which enters the first logic state after varying between the first logic state and the second logic state a preset number of times, and
wherein, when the lock signal enters the first logic state after varying between the first logic state and the second logic state the preset number of times or more, the lock-signal masking unit outputs a lock signal of the first logic state to the transmission circuit.

7. The image transmission/reception system according to claim 3,
wherein the image transmitting apparatus further includes an adding unit that adds an error detecting code to image data which is to be transmitted to the image receiving apparatus,
wherein the image receiving apparatus further includes a detection unit that performs error detection on the image data by using the error detecting code added to the image data obtained by the reception circuit, and
wherein, in response to the detection unit detecting an error in the image data, the lock-signal transmission controller outputs, to the image transmitting apparatus, a signal as a lock signal, the output signal varying in the preset manner.

8. A non-transitory computer readable medium storing a program causing a computer to execute a process comprising:
in an image transmitting apparatus including a transmission circuit that, in response to an input lock signal switching from a first logic state to a second logic state, the first logic state indicating that communication has not been established, the second logic state indicating that communication has been established, transmits, to an image receiving apparatus, transmission data in which a clock signal is superimposed on image data, receiving the lock signal from the image receiving apparatus; and
even when the received lock signal enters the second logic state and then varies to the first logic state, only in a case where the first logic state continues for a preset time or longer, outputting a lock signal of the first logic state to the transmission circuit.
